(19) United States
(12) Patent Application Publication
(10) Pub. No.: US 2026/0155392 A1
(43) Pub. Date: Jun. 4, 2026

(54) ELECTRODE MEMBER

(71) Applicant: TOYOTA JIDOSHA KABUSHIKI KAISHA, Toyota-shi (JP)

(72) Inventors: Mitsuru TATEISHI, Toyota-shi (JP); Masashi UEDA, Toyota-shi (JP); Jun IZUMI, Toyota-shi (JP); Shizuka MASUOKA, Nagoya-shi (JP); Aya SATO, Nagoya-shi (JP); Keitaro MACHIDA, Hamamatsu-shi (JP); Yuji KATAYAMA, Okazaki-shi (JP); Tatsuya YAMAMOTO, Toyohashi-shi (JP)

(73) Assignee: TOYOTA JIDOSHA KABUSHIKI KAISHA, Toyota-shi (JP)

(21) Appl. No.: 19/386,315

(22) Filed: Nov. 12, 2025

(30) Foreign Application Priority Data
Dec. 3, 2024 (JP) 2024-210535

(51) Int. Cl. H01M 4/66

(52) U.S. Cl. CPC H01M 4/668; H01M 4/667

(57) ABSTRACT

An electrode member includes: a substrate that includes a resin substrate and a conductive layer provided on the resin substrate; and an active material layer provided on the conductive layer. The substrate includes a coated region where the active material layer is applied and an uncoated region where the active material layer is not applied. The resin substrate is made of a crystalline polymer. The crystallinity of the crystalline polymer located in the coated region is higher than that of the crystalline polymer located in the uncoated region.

### CROSS-REFERENCE TO RELATED APPLICATION

This application claims priority to Japanese Patent Application No. 2024-210535 filed on Dec. 3, 2024. The disclosure of the above-identified application, including the specification, drawings, and claims, is incorporated by reference herein in its entirety.

### BACKGROUND

### 1. Technical Field

The present disclosure relates to electrode members.

### 2. Description of Related Art

Japanese Unexamined Patent Application Publication No. 2019-096592 (JP 2019-096592 A) discloses an electrode assembly in which a cathode member and an anode member, both in the form of a sheet, are wound with a separator interposed therebetween. In this electrode assembly, an electrode member in which a conductive layer and an active material layer are laminated in this order on the surface of an insulating substrate is used as at least one of the cathode member and the anode member. The conductive layer includes a first portion where the active material layer is applied and a second portion protruding from the first portion. A through hole penetrating in the thickness direction is provided in the second portion and in a portion of the insulating substrate corresponding to the second portion. In the present specification, the term “conductive” means “electrically conductive” unless specified otherwise.

### SUMMARY

A manufacturing process of an electrode member includes a pressing step in which an active material layer and a substrate are pressed between rollers in order to fix the active material layer onto the substrate. The substrate includes an uncoated region where no active material layer is applied. During the pressing step, the rollers come into contact with the active material layer but do not come into contact with the uncoated region. Accordingly, a coated region of the substrate where the active material layer is applied elongates due to pressing, while the uncoated region of the substrate is less likely to elongate. This may cause a difference in elongation between the coated region and the uncoated region. When a substrate including a resin member is used, there is a concern that the uncoated region may bend or wrinkle due to the difference in elongation.

The present disclosure has been made in view of the above issue, and an object thereof is to provide an electrode member that can reduce wrinkling and bending in an uncoated region where no active material layer is applied.

An electrode member according to the present disclosure incudes: a substrate that includes a resin substrate and a conductive layer provided on the resin substrate; and an active material layer provided on the conductive layer. The substrate includes a coated region where the active material layer is applied and an uncoated region where the active material layer is not applied. The resin substrate is made of a crystalline polymer. The crystallinity of the crystalline polymer located in the coated region is higher than the crystallinity of the crystalline polymer located in the uncoated region.

A manufacturing process of an electrode member typically includes a pressing step in which an active material layer and a substrate are pressed between a pair of rollers in order to fix the active material layer onto the substrate. In the pressing step, the coated region of the substrate where the active material layer is applied is more likely to elongate as the coated region is pressed between the rollers. On the other hand, the uncoated region of the substrate where the active material layer is not applied is less likely to elongate as the uncoated region is not pressed between the rollers.

In the above configuration, since the crystallinity of the resin substrate is high in the coated region that is susceptible to elongation, the elongation in the coated region can be reduced. Furthermore, since the crystallinity of the resin substrate is low in the uncoated region that is less susceptible to elongation, the elongation in the uncoated region can be promoted in the pressing step. As a result, the elongation difference between the coated region and the uncoated region can be reduced. This configuration can reduce wrinkling and deformation into a curved shape in the region where the active material layer is not applied, namely the region that is less susceptible to elongation.

In the electrode member according to the present disclosure, the crystalline polymer may be polypropylene.

Polypropylene is a material that is less susceptible to elongation than polyethylene etc. Therefore, when polypropylene is used for the resin substrate, the elongation difference of the resin substrate between the coated region and the uncoated region can further be reduced.

The present disclosure can provide an electrode member that can reduce wrinkling and bending in an uncoated region where no active material layer is applied.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery according to a first embodiment;

FIG. 2 is an exploded perspective view of the battery according to the first embodiment;

FIG. 3 is a sectional view of the battery in FIG. 1, taken along line III-III and viewed in the direction of the arrows;

FIG. 4 is a cross-sectional view of an electrode assembly in FIG. 3, taken along line IV-IV and viewed in the direction of the arrows;

FIG. 5 is a sectional view of a first electrode member in an unwound state according to the first embodiment; and

FIG. 6 is a sectional view of a second electrode member in an unwound state according to a first modification.

### DETAILED DESCRIPTION OF EMBODIMENTS

Hereinafter, a first embodiment of the present disclosure will be described in detail with reference to the drawings. In the first embodiment described below, the same or common portions are denoted by the same signs throughout the drawings, and description thereof will not be repeated.

### First Embodiment

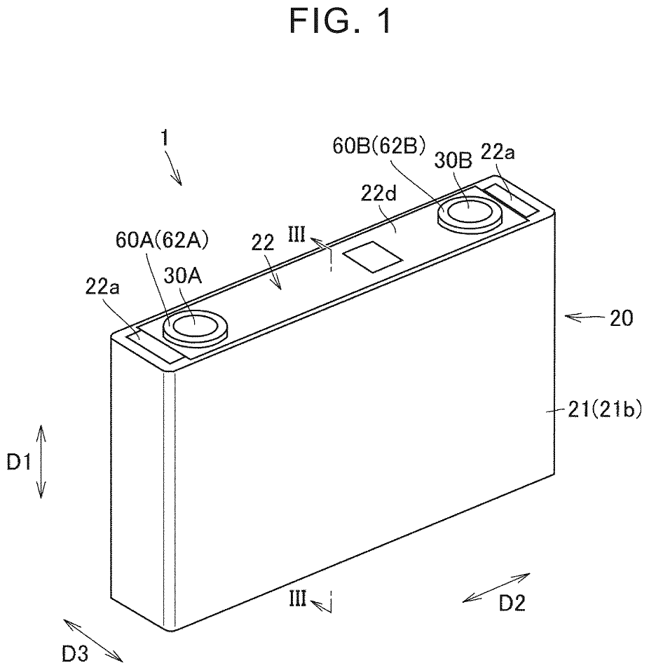

FIG. 1 is a perspective view of a battery according to the first embodiment. As shown in FIG. 1, a battery 1 according to the present embodiment is a so-called prismatic battery. The battery 1 may be a secondary battery configured to be charged and discharged such as a lithium-ion battery or a nickel metal hydride battery. The battery 1 may be used, for example, as a cell included in an energy storage module mounted on an electrified vehicle.

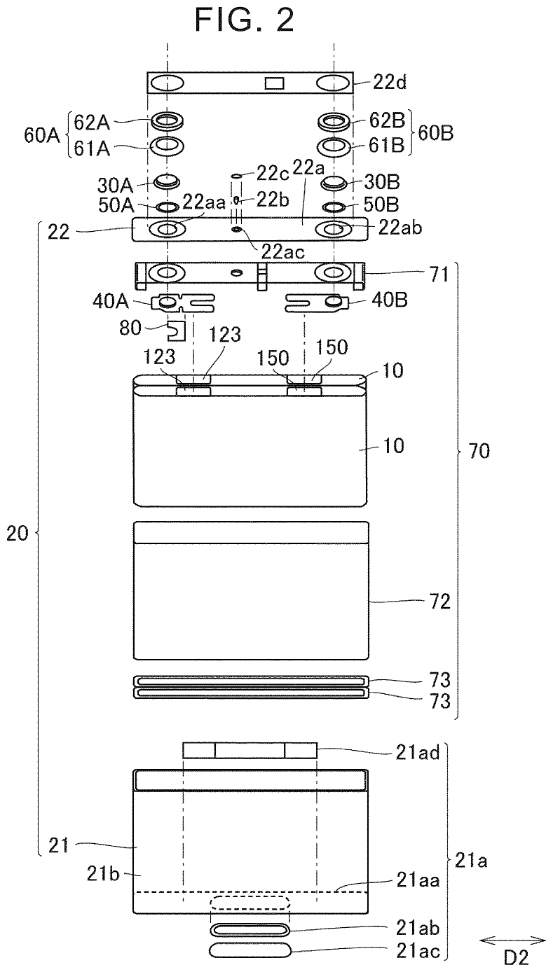

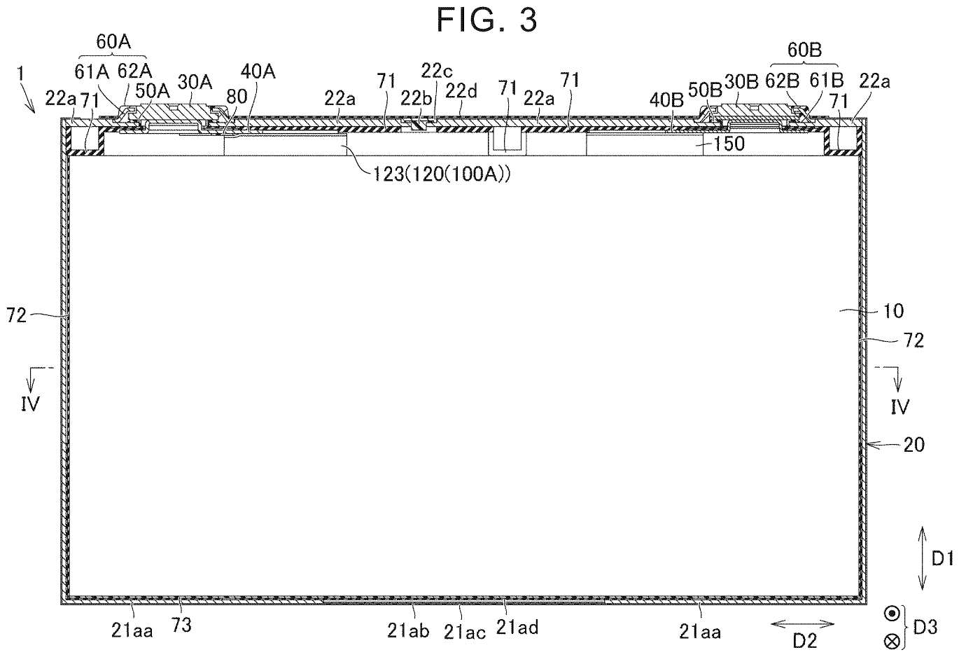

FIG. 2 is an exploded perspective view of the battery according to the first embodiment. FIG. 3 is a sectional view of the battery in FIG. 1, taken along line III-III and viewed in the direction of the arrows. As shown in FIGS. 1 to 3, the battery 1 of the first embodiment includes an electrode assembly 10, a case 20, a first external terminal 30A, a second external terminal 30B, a first connecting member 40A, a second connecting member 40B, a first seal ring 50A, a second seal ring 50B, a first terminal support portion 60A, a second terminal support portion 60B, an insulating member 70, and a fuse protection portion 80.

The case 20 is conductive. A conductive portion of the case 20 is made of, for example, a metal such as aluminum. The case 20 houses the electrode assembly 10. The case 20 also contains an electrolyte solution, not shown.

The case 20 includes a case body 21 and a lid 22. The case body 21 includes a bottom wall 21a and a peripheral wall 21b standing from the bottom wall 21a.

The bottom wall 21a includes a bottom body 21aa, a pressure relief valve 21ab, an outer protective film 21ac, and an inner protective film 21ad. The peripheral wall 21b stands from the bottom body 21aa. The pressure relief valve 21ab is provided in the bottom body 21aa. The outer protective film 21ac covers the pressure relief valve 21ab from the outside. The inner protective film 21ad covers the pressure relief valve 21ab from the inside. The bottom body 21aa and the pressure relief valve 21ab are made of a metal such as aluminum.

An opening is formed at the upper end of the peripheral wall 21b. The peripheral wall 21b has a substantially rectangular outer shape as viewed from the opening direction of the opening (the direction normal to the opening plane). The opening and the bottom wall 21a are arranged in a first direction D1. The first direction D1 may be the height direction or the up-down direction of the battery 1. The peripheral wall 21b is made of a metal such as aluminum.

The lid 22 includes a lid body 22a, a sealing plug 22b, a plug cover 22c, and an insulating cover 22d.

The lid body 22a is joined to the peripheral wall 21b by welding etc. so as to close the opening of the peripheral wall 21b. The lid body 22a has a first connecting hole 22aa, a second connecting hole 22ab, and a filling hole 22ac. The filling hole 22ac is a through hole for injecting an electrolyte solution into the case body 21 in a manufacturing process of the battery 1.

The sealing plug 22b seals the filling hole 22ac. The plug cover 22c covers the filling hole 22ac and the sealing plug 22b. The insulating cover 22d covers the filling hole 22ac, the sealing plug 22b, and the plug cover 22c.

The first external terminal 30A and the second external terminal 30B are provided in the battery 1 so as to be exposed to the outside. The first connecting member 40A and the second connecting member 40B are conductive. At least part of the first connecting member 40A and at least part of the second connecting member 40B are disposed inside the case 20.

The first external terminal 30A or the first connecting member 40A is inserted through the first connecting hole 22aa. The first external terminal 30A and the first connecting member 40A are joined together. The first connecting member 40A is joined to the electrode assembly 10. Accordingly, the first external terminal 30A is electrically connected to the electrode assembly 10.

The second external terminal 30B or the second connecting member 40B is inserted through the second connecting hole 22ab. The second external terminal 30B and the second connecting member 40B are joined together. The second connecting member 40B is joined to the electrode assembly 10. Accordingly, the second external terminal 30B is electrically connected to the electrode assembly 10.

In the present embodiment, the first external terminal 30A is a cathode terminal, and the second external terminal 30B is an anode terminal. The first external terminal 30A and the second external terminal 30B are arranged in a second direction D2. The second direction D2 is a direction perpendicular to the first direction D1.

The first seal ring 50A is provided along the first connecting hole 22aa. The first seal ring 50A is provided in a gap between the lid body 22a and the first external terminal 30A to seal the gap. The second seal ring 50B is provided along the second connecting hole 22ab. The second seal ring 50B is provided in a gap between the lid body 22a and the second external terminal 30B to seal the gap. The first seal ring 50A and the second seal ring 50B are electrically insulating.

The first terminal support portion 60A is retained by the lid body 22a. The first terminal support portion 60A supports the first external terminal 30A from the outer peripheral side of the first external terminal 30A. The first terminal support portion 60A includes a first retaining ring 61A and a first covering ring 62A. The first retaining ring 61A extends annularly so as to surround the first connecting hole 22aa, and is directly retained by the lid body 22a. The first covering ring 62A covers the first retaining ring 61A. The first retaining ring 61A supports the first external terminal 30A via the first covering ring 62A. The first covering ring 62A is a resin member that is electrically insulating or relatively weakly conductive.

The second terminal support portion 60B is retained by the lid body 22a. The second terminal support portion 60B supports the second external terminal 30B from the outer peripheral side of the second external terminal 30B. The second terminal support portion 60B includes a second retaining ring 61B and a second covering ring 62B. The second retaining ring 61B extends annularly so as to surround the second connecting hole 22ab, and is directly retained by the lid body 22a. The second covering ring 62B covers the second retaining ring 61B. The second retaining ring 61B supports the second external terminal 30B via the second covering ring 62B. The second covering ring 62B is a resin member that is electrically insulating.

The insulating member 70 is electrically insulating. The insulating member 70 is disposed between a plurality of the electrode assemblies 10 and the case 20. The insulating member 70 electrically insulates the electrode assemblies 10 from the case 20. The insulating member 70 includes an insulating bracket 71, a peripheral surface insulating portion 72, and a bottom surface insulating portion 73.

The insulating bracket 71 is disposed between the electrode assemblies 10 and the lid body 22a. The insulating bracket 71 has relatively high rigidity and is in contact with both the electrode assemblies 10 and the lid body 22a. The electrode assemblies 10 are thus fixed in the case 20 in the first direction D1.

The peripheral surface insulating portion 72 is disposed between the electrode assemblies 10 and the peripheral wall 21b. The peripheral surface insulating portion 72 is a member in the form of a film.

The bottom surface insulating portion 73 is disposed between each of the electrode assemblies 10 and the bottom wall 21a. The bottom surface insulating portion 73 is a member in the form of a film. In the present embodiment, the bottom surface insulating portion 73 is bonded to the electrode assembly 10. The bottom surface insulating portion 73 covers part of the bottom surface of the electrode assembly 10. The bottom surface insulating portion 73 may cover the entire bottom surface.

As shown in FIG. 2, the battery 1 according to the present embodiment includes a plurality of electrode assemblies 10. The battery 1 typically includes two electrode assemblies 10. The electrode assemblies 10 are arranged in a third direction D3. The third direction D3 is a direction perpendicular to both the first direction D1 and the second direction D2. The peripheral surface insulating portion 72 may integrally cover the electrode assemblies 10 such that the electrode assemblies 10 are secured together.

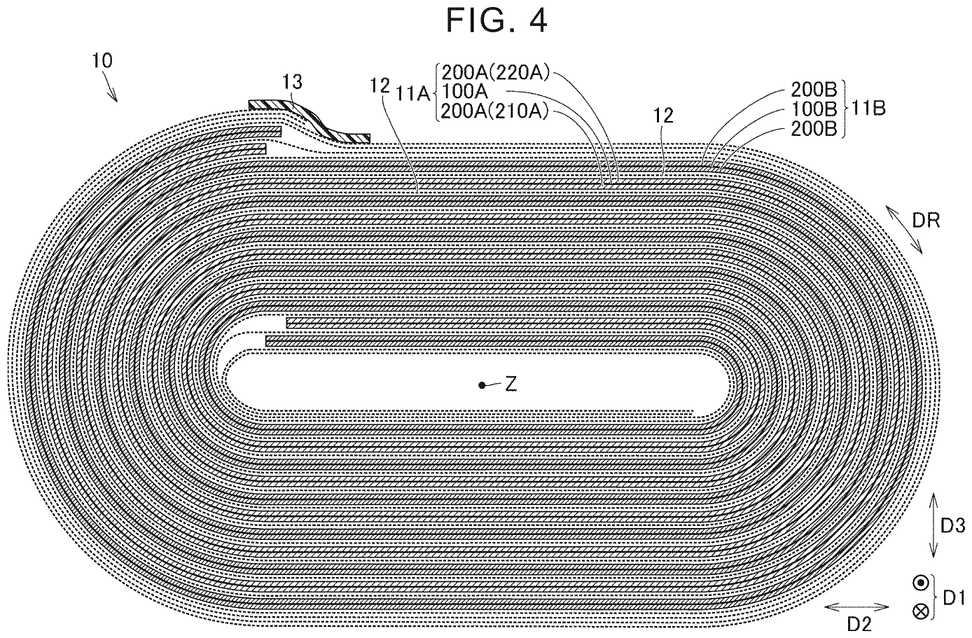

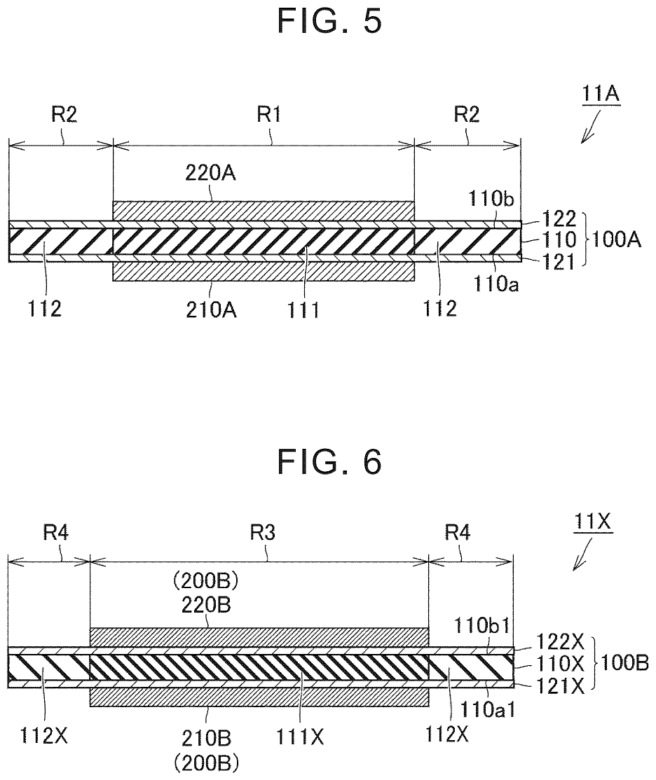

The electrode assembly 10 is provided with a plurality of first tabs 150A and a plurality of second tabs 150B. A first end of each of the first tabs 150A is connected to a first conductive layer 121 (see FIG. 5) and a second conductive layer 122 (see FIG. 5) of a first electrode member 11A (see FIG. 4) that will be described later. A second end of each of the first tabs 150A is joined to the first connecting member 40A by ultrasonic welding etc.

A first end of each of the second tabs 150B is connected to a second substrate 100B of a second electrode member 11B (see FIG. 4) that will be described later. A second end of each of the second tabs 150B is joined to the second connecting member 40B by ultrasonic welding etc.

FIG. 4 is a cross-sectional view of the electrode assembly in FIG. 3, taken along line IV-IV and viewed in the direction of the arrows. The electrode assembly 10 includes the first electrode member 11A, the second electrode member 11B, a separator 12, and a tape member 13. In the electrode assembly 10, the first electrode member 11A, the second electrode member 11B, and the separator 12 are wound around a winding axis Z. The first embodiment illustrates a case where the electrode assembly 10 is a wound electrode assembly. However, the present disclosure is not limited to this. The electrode assembly 10 may be a laminated electrode assembly in which the first electrode member 11A, the second electrode member 11B, and the separator 12 are laminated in one direction (e.g., the third direction D3). In FIG. 4, the separator 12 is schematically shown by dashed lines.

The first electrode member 11A and the second electrode member 11B are in the form of a sheet. The electrode assembly 10 is formed by winding the first electrode member 11A and the second electrode member 11B with one or more separators 12 interposed therebetween. For example, the first electrode member 11A is a cathode, and the second electrode member 11B is an anode.

The first electrode member 11A includes a first substrate 100A and a first active material layer 200A. The first active material layer 200A has the same polarity as the first electrode member 11A. The first active material layer 200A is, for example, a cathode active material layer. A known material can be used as the cathode active material layer.

The first active material layer 200A is provided on the front and back surfaces of the first substrate 100A. The detailed structure of the first substrate 100A will be described later with reference to FIG. 5.

The second electrode member 11B includes the second substrate 100B and a second active material layer 200B. The second active material layer 200B has the same polarity as the second electrode member 11B. The second electrode member 11B is, for example, an anode active material layer. A known material can be used as the anode active material layer.

The second substrate 100B is, for example, a copper-containing metal member such as copper foil. The second active material layer 200B is provided on the front and back surfaces of the second substrate 100B.

The separator 12 is provided between the first electrode member 11A and the second electrode member 11B. The separator 12 separates the first electrode member 11A from the second electrode member 11B while allowing ions to travel between the first electrode member 11A and the second electrode member 11B. The ions are, for example, lithium ions. The separator 12 is electrically insulating.

The separator 12 is located on the radially innermost side of the electrode assembly 10. The separator 12 is also located on the radially outermost side of the electrode assembly 10. The outer peripheral edge of the separator 12 in a winding direction DR is fixed by the tape member 13 placed on the outer peripheral surface of the separator 12.

The separator 12 may contain, for example, a polyolefin-based resin etc. For example, the separator 12 may be made substantially of a polyolefin-based resin. The polyolefin-based resin may include, for example, at least one selected from the group consisting of polyethylene (PE) and polypropylene (PP).

FIG. 5 is a sectional view of the first electrode member in an unwound state according to the first embodiment. Specifically, FIG. 5 is a sectional view of the first electrode member 11A taken along a plane perpendicular to the second direction.

As shown in FIG. 5, the first substrate 100A of the first electrode member 11A includes a coated region R1 where the first active material layer 200A is applied, and an uncoated region R2 where the first active material layer 200A is not applied. In the first electrode member 11A, the first substrate 100A includes a first resin substrate 110, and the first conductive layer 121 and the second conductive layer 122 that are laminated on the first resin substrate 110.

The first resin substrate 110 has a first surface 110a and a second surface 110b in a thickness direction. The thickness direction is parallel to a laminating direction in which the first substrate 100A and the first active material layer 200A are laminated.

The first resin substrate 110 includes a first portion 111 and a second portion 112 in a width direction perpendicular to the laminating direction. The width direction is parallel to the first direction D1 in a wound state.

The first portion 111 is located in a central portion in the width direction. The first portion 111 overlaps the first active material layer 200A in the laminating direction. The first portion 111 is located in the coated region R1.

The second portion 112 is located on both outer sides of the first portion 111 in the width direction. The second portion 112 does not overlap the first active material layer 200A in the laminating direction. The second portion 112 is located in the uncoated region R2.

The first resin substrate 110 is made of a crystalline polymer. Examples of the crystalline polymer include polyethylene (PE), polypropylene (PP), polyamide (PA), polyethylene terephthalate (PET), and polyphenylene sulfide (PPS).

The crystallinity of the first resin substrate 110 (crystalline polymer) in the coated region R1 is higher than that of the first resin substrate 110 (crystalline polymer) in the uncoated region R2. The crystallinity can be measured using a differential scanning calorimeter (DSC).

The first conductive layer 121 is formed on the first surface 110a. The first conductive layer 121 is formed in both the coated region R1 and the uncoated region R2. The second conductive layer 122 is formed on the second surface 110b. The second conductive layer 122 is formed in both the coated region R1 and the uncoated region R2.

The first conductive layer 121 and the second conductive layer 122 are made of a metal material containing aluminum. The first conductive layer 121 and the second conductive layer 122 may be respectively formed on the first surface 110a and the second surface 110b by vapor deposition etc. The first conductive layer 121 and the second conductive layer 122 may be made of metal foil, and may be respectively bonded to the first surface 110a and the second surface 110b by an adhesive.

The first active material layer 200A is formed on the first conductive layer 121 and the second conductive layer 122. Specifically, the first active material layer 200A is formed on central portions of the first and second conductive layers 121, 122 in the width direction.

The first active material layer 200A includes a first portion 210A and a second portion 220A. The first portion 210A is formed on the first conductive layer 121. The second portion 220A is formed on the second conductive layer 122.

A manufacturing process of an electrode member typically includes a pressing step in which the first active material layer 200A and the first substrate 100A are pressed between a pair of rollers in order to fix the first active material layer 200A onto the first substrate 100A. In the pressing step, the coated region R1 of the first substrate 100A where the first active material layer 200A is applied is more likely to elongate as the coated region R1 is pressed between the rollers. On the other hand, the uncoated region R2 of the first substrate 100A where the first active material layer 200A is not applied is less likely to elongate as the uncoated region R2 is not pressed between the rollers.

In the present embodiment, the crystallinity of the first resin substrate 110 is higher in the coated region R1 that is susceptible to elongation than in the uncoated region R2 that is less susceptible to elongation. This can reduce elongation in the coated region R1. Furthermore, since the crystallinity of the first resin substrate 110 is lower in the uncoated region R2 that is less susceptible to elongation, elongation in the uncoated region R2 can be promoted in the pressing step. As a result, the elongation difference between the coated region R1 and the uncoated region R2 can be reduced. This configuration can reduce wrinkling and deformation into a curved shape in the region where the first active material layer 200A is not applied, namely the region that is less susceptible to elongation.

Polypropylene is a material that is less susceptible to elongation than polyethylene etc. Therefore, when polypropylene is used as the crystalline polymer for the first resin substrate 110, the elongation difference of the first resin substrate 110 between the coated region R1 and the uncoated region R2 can further be reduced.

### First Modification

FIG. 6 is a sectional view of a second electrode member in an unwound state according to a first modification. A second electrode member 11X according to the first modification will be described with reference to FIG. 6. The second electrode member 11X of the first modification can be applied to the electrode assembly 10 of the first embodiment.

As shown in FIG. 6, the second electrode member 11X is different from the second electrode member 11B of the first embodiment in the configuration of the second substrate 100B. The configuration of the second electrode member 11X of the first modification is otherwise substantially the same as the configuration of the second electrode member 11B of the first embodiment.

As shown in FIG. 6, the second substrate 100B of the second electrode member 11X includes a coated region R3 where the second active material layer 200B is applied, and an uncoated region R4 where the second active material layer 200B is not applied. In the second electrode member 11X, the second substrate 100B includes a second resin substrate 110X, and a third conductive layer 121X and a fourth conductive layer 122X that are laminated on the second resin substrate 110X.

The second resin substrate 110X has a first surface 110a1 and a second surface 110b1 in a thickness direction. The thickness direction is parallel to a laminating direction in which the second substrate 100B and the second active material layer 200B are laminated. The second resin substrate 110X includes a first portion 111X and a second portion 112X in the width direction.

The first portion 111X is located in a central portion in the width direction. The first portion 111X overlaps the second active material layer 200B in the laminating direction. The first portion 111X is located in the coated region R3.

The second portion 112X is located on both outer sides of the first portion 111X in the width direction. The second portion 112X does not overlap the second active material layer 200B in the laminating direction. The second portion 112X is located in the uncoated region R4.

The second resin substrate 110X is made of a crystalline polymer. Examples of the crystalline polymer include polyethylene (PE), polypropylene (PP), polyamide (PA), polyethylene terephthalate (PET), and polyphenylene sulfide (PPS).

The crystallinity of the second resin substrate 110X (crystalline polymer) in the coated region R3 is higher than that of the second resin substrate 110X (crystalline polymer) in the uncoated region R4.

The third conductive layer 121X is formed on the first surface 110a1. The third conductive layer 121X is formed in both the coated region R3 and the uncoated region R4. The fourth conductive layer 122X is formed on the second surface 110b1. The fourth conductive layer 122X is formed in both the coated region R3 and the uncoated region R4.

The third conductive layer 121X and the fourth conductive layer 122X are made of a metal material containing copper. The third conductive layer 121X and the fourth conductive layer 122X may be respectively formed on the first surface 110a1 and the second surface 110b1 by vapor deposition etc. The third conductive layer 121X and the fourth conductive layer 122X may be made of metal foil, and may be respectively bonded to the first surface 110a1 and the second surface 110b1 by an adhesive.

The second active material layer 200B is formed on the third conductive layer 121X and the fourth conductive layer 122X. Specifically, the second active material layer 200B is formed on central portions of the third and fourth conductive layers 121X, 122X in the width direction.

The second active material layer 200B includes a first portion 210B and a second portion 220B. The first portion 210B is formed on the third conductive layer 121X. The second portion 220B is formed on the fourth conductive layer 122X.

Even with this configuration, the second electrode member 11B of the first modification has substantially the same effects as those of the first electrode member 11A of the first embodiment.

In a battery including the second electrode member 11B according to the first modification, the crystallinity of the crystalline polymer located in the coated region is higher than that of the crystalline polymer located in the uncoated region in both the first electrode member 11A and the second electrode member 11B. This configuration can reduce wrinkling and bending in the uncoated region in both the first electrode member 11A and the second electrode member 11B.

### Other Modifications

The first embodiment described above illustrates the case where the first electrode member 11A is a cathode and the second electrode member 11B is an anode. However, the present disclosure is not limited to this. The first electrode member 11A may be an anode, and the second electrode member 11B may be a cathode. In this case, the members constituting the first electrode member 11A and the second electrode member 11B may be selected according to the polarity of the corresponding substrate.

The embodiments and modifications disclosed herein should be considered to be illustrative in all respects and not restrictive. The scope of the present disclosure is set forth in the claims, and includes all modifications within the meaning and scope equivalent to the claims.

What is claimed is:

1. An electrode member comprising:
a substrate that includes a resin substrate and a conductive layer provided on the resin substrate; and
an active material layer provided on the conductive layer, wherein:
the substrate includes a coated region where the active material layer is applied and an uncoated region where the active material layer is not applied;
the resin substrate is made of a crystalline polymer; and
crystallinity of the crystalline polymer located in the coated region is higher than crystallinity of the crystalline polymer located in the uncoated region.

2. The electrode member according to claim 1, wherein the crystalline polymer is polypropylene.
